(19) United States
(12) Patent Application Publication
(10) Pub. No.: US 2003/0055673 A1
(43) Pub. Date: Mar. 20, 2003

(54) Method and device for operating a technical arrangement comprising several data processing systems

(76) Inventor: Thomas Merklein, Erlangen (DE)

Correspondence Address: HARNESS, DICKEY & PIERCE, P.L.C., P.O.BOX 8910, RESTON, VA, 20195, US

(21) Appl. No.: 10/240,846

(22) PCT Filed: Mar. 23, 2001
(86) PCT No.: PCT/DE01/01138

(30) Foreign Application Priority Data
Apr. 5, 2000 (DE) 10016862.0

(51) Int. Cl. G06F 17/60

(52) U.S. Cl. 705/1

(57) ABSTRACT

The invention relates to a method and a device for operating a technical arrangement that comprises several data processing systems that are used for solving different tasks of the technical arrangement. Information has to be exchanged between the data processing systems. Communication between the data processing systems is particularly efficient when a uniform object structure for the information to be transmitted is used in the entire arrangement.

The invention relates to a method for operating a technical arrangement, said technical arrangement comprising several data processing systems that are used for solving the different tasks of the technical arrangement. The invention also relates to a device for operating such a technical arrangement.

In a modern technical arrangement a multiplicity of data processing systems are used for solving the various tasks of the technical arrangement. For this purpose, for instance, information is exchanged between the data processing systems which is then processed in the particular data processing system that specializes in the respective task.

The hardware and software systems of the arrangement can be gradually added to the arrangement over the years, they may originate from different manufacturers and they may support and use different methods of communication.

The data processed in each case is usually present in the data processing systems in different object structures which are optimally adapted to the respective system. For communication between the data processing systems, transmissions, for example over a bus system, that transport data or fixed structures are used. In order to convert the different object structures implemented in the data processing systems into one another, so-called drivers are therefore necessary. Drivers must often be provided even at both ends of the transmission link. The driver at the sending data processing system end converts its object structure into the data structure used by the transmission medium, and the driver at the receiving data processing system end then converts this data structure into an object structure which the receiving data processing system can process. The number of various interfaces which have to be adapted to one another by means of drivers so that the data processing systems can communicate with one another thus also rises in line with the number of data processing systems communicating in a technical arrangement. A commercially available process information system may have, for example, over 200 or more different interfaces.

In the field of archive systems, an improvement of the abovementioned interface problem is described in DE 198 14 348 A1. In this case an interpreter is used for communication with various electronic archive systems and the interpreter receives a query from a user which is formulated independently of a query language used in a special archive system. The interpreter then converts said non-archive-system-specific query into an archive-system-specific form, and the query is executed in a selected archive system. The interpreter thus realizes a communication connection between a user that does not know an archive-system-specific query language and various archive systems that each process a specific query language. In the system and method proposed in the abovementioned laid-open application, a special driver is therefore only necessary at the archive systems to be queried; the interpreter accepts the specification of the information to be queried in a non-specific form and then converts it into a specific form adapted to the respective archive system selected.

By this means communication is simplified inasmuch as the sender (in this case the user requesting archive information) does not need to know all the archive-system-specific query languages to obtain the desired information; the user is supported by an interpreter which accepts the specification of the information to be queried in a general structure and then converts it into a specific structure.

Despite the aforesaid improvement in communication, many problems remain unresolved, such as, for example, communication of the data processing systems (the archive systems in the abovementioned laid-open application) among one another. In a technical arrangement comprising several data processing systems, communication between the data processing systems is an absolute necessity; this is not addressed in the abovementioned laid-open application. Moreover, the various systems (in this case the archive systems) each use different object structures which further necessitate a driver for adapting to the non-archive-system-specific form of the query.

The object of the invention is therefore to disclose a method and a device for operating a technical arrangement comprising several data processing systems, with the aid of which communication between the data processing systems is greatly simplified, in particular with respect to the required drivers that convert the various data structures into one another.

According to the invention the method of the type mentioned at the beginning comprises the following steps:

1. The tasks of the technical arrangement are defined in advance.

2. The tasks are allocated to the data processing systems in advance.

3. Blank forms are created in advance, on which forms the variables whose contents are provided for performing at least one task for the exchange between the data processing systems during subsequent operation are declared in each case.

4. During operation of the arrangement, the tasks of the technical arrangement are processed by the data processing systems, wherein the particular data processing systems that make information values available to other data processing systems enter at least one information value on at least one blank form relating to the task, and the particular data processing systems that receive information values from at least one data processing system read out at least one information value from at least one blank form relating to the task, which form was filled out by at least one other data processing system.

The aim of the method according to the invention is to unify the object structures used by the various data processing systems by structuring the data using blank forms. With this method each data processing system knows at least the particular blank forms relating to the particular tasks to be processed by the respective data processing system. The structure of the information to be processed is defined by the blank forms; it is therefore unnecessary to convert different data structures into one another for data transmission. The transmission of information is accomplished by a first data processing system entering information values in one or more blank forms and a second data processing system extracting information values from filled out blank forms. By dispensing with the need for conversions between various object structures, communication using the method according to the invention becomes faster and less prone to errors.

Even where data processing systems that do not or cannot process any of the data structures according to the invention are present in a technical arrangement, the method according to the invention can still bring about an improvement in communication. Although in this case conversion from a specific data structure not according to the invention into the data structure according to the invention is necessary, drivers that perform such conversions need only be provided for those data processing systems in the technical arrangement that process a data structure not according to the invention. Furthermore, such drivers are required only at the respective data processing systems; no further conversions are required as soon as the driver has converted the data into the data structure according to the invention. Data processing systems that function according to the invention can exchange information among one another without adapting their data structure.

In an advantageous development of the invention, additional variables are declared on the blank forms during operation of the arrangement.

During operation of the arrangement, the tasks to be processed by the data processing systems may be extended for example. In some circumstances it may then be necessary to transmit the contents of variables that have not yet been declared on the blank forms created in advance. If said additionally required variables are then declared on the blank forms during operation, all data processing systems that process the respective task can supply said additionally declared variables with information values, or read out information values from said additionally declared variables respectively. The data object structure according to the invention which is used for communication thus remains uniform across the entire arrangement even if the tasks are subsequently extended.

In a further advantageous development of the invention, additional blank forms are created during operation of the arrangement.

If new tasks which must be processed by the data processing systems are identified during operation of the arrangement, the communication must also be adapted to these new circumstances. The information that must be transmitted to solve the new tasks is specified on additional blank forms. The particular data processing systems that process the new tasks can then enter information values in said additionally created blank forms, or read out information values from them respectively. The data object structure used by the method according to the invention for communication thus remains uniform across the entire arrangement even if new tasks are added during operation.

In a further advantageous development of the invention, the blank forms are collected in at least one form container.

Collection of the blank forms in at least one form container ensures that a clear overview of all information to be transmitted across the entire arrangement is maintained. The blank forms on which the information to be transmitted is specified are not scattered over various locations, but are collected in one or more form containers. For instance, with respect to the communications data structure, the project planner of a data processing system being newly added to the technical arrangement need only acquire an overview of the contents of the at least one form container to obtain an idea of which data structure to select for communication with the already existing data processing systems in order to realize efficient communication according to the invention. Blank forms are advantageously collected in exactly one form container.

In this way the specifications of all information relevant for communication are concentrated at a single location; the overall structure of the information to be transmitted across the entire arrangement is therefore especially clear.

It is furthermore advantageous if a blank form is a—in the electronic data processing sense—composite variable.

Since the data processing systems of the technical arrangement are in most cases electronic computer units, the blank forms are designed as electronic data processing structures. A composite variable which comprises a plurality of variables of possibly different types is ideal for this purpose. The composite variable is addressed via a name (“form name”) and the variables it contains are addressed by means of an affix to said name (“form fields”). In this way a blank form is realized in a clear electronic data processing structure that can be readily processed by a data processing system.

In another advantageous development of the invention, a form container is an electronic data processing object structure.

According to this advantageous development of the invention, for the purposes of electronic data processing a form container should be designed in such a way that the blank forms contained in the form container can be specifically addressed by means of a uniform container-wide designation and any applicable affix. In this context, an object structure is a combination of a plurality of substructures—represented by the blank forms—to form an overall structure, an object.

In another development of the invention, the tasks of the technical arrangement comprise a plurality of subtasks in each case.

In many cases it is expedient to split the tasks into a plurality of subordinate subtasks in each case. The solution of the task then consists of the solutions of the subtasks. If the task is not solved, then the problem can be readily located by examining the part-solutions. If a communication problem between data processing systems arises in connection with the solution of a subtask, then the non-transmitted or incorrectly transmitted information causing the problem can be located by examining the part-solutions along with the information read or written in connection therewith.

In another advantageous development of the invention, the blank forms are hierarchically structured and at least one subtask is assigned to each hierarchical level.

By virtue of this assignment, the relationship between the subtasks, the superordinate tasks and the blank forms is particularly clear. For instance, a subsequent extension or change to a subtask, a task or a blank form is especially easy. Moreover, in the case of communication in relation to a task, it is not always necessary to transmit all associated information; for instance the information relating to a subtask, or even less information, may also suffice. If the information is hierarchically structured as in this advantageous development of the invention, then contiguous blocks of information relating to a task, a subtask or even just a part of a subtask can be transmitted. Thus it is not necessary for information that may be scattered across a plurality of forms to be collected in a first step in order to then be transmitted in a second step; rather the hierarchical structuring of the information described permits the direct transmission of at least contiguous blocks of information.

The invention furthermore leads to a device for operating a technical arrangement comprising several data processing systems. The tasks of the technical arrangement are allocated to the data processing systems, the blank forms are created in a computer unit and the data processing systems are trained to enter information values on the blank forms and read out information values from said forms during operation of the technical arrangement. The computer unit in which the blank forms are created need not necessarily be a separate computer unit. Its function may be performed by one of the data processing systems, or the blank forms are created in parallel on all data processing systems.

Four exemplary embodiments of the invention are described with reference to the accompanying drawings, in which:

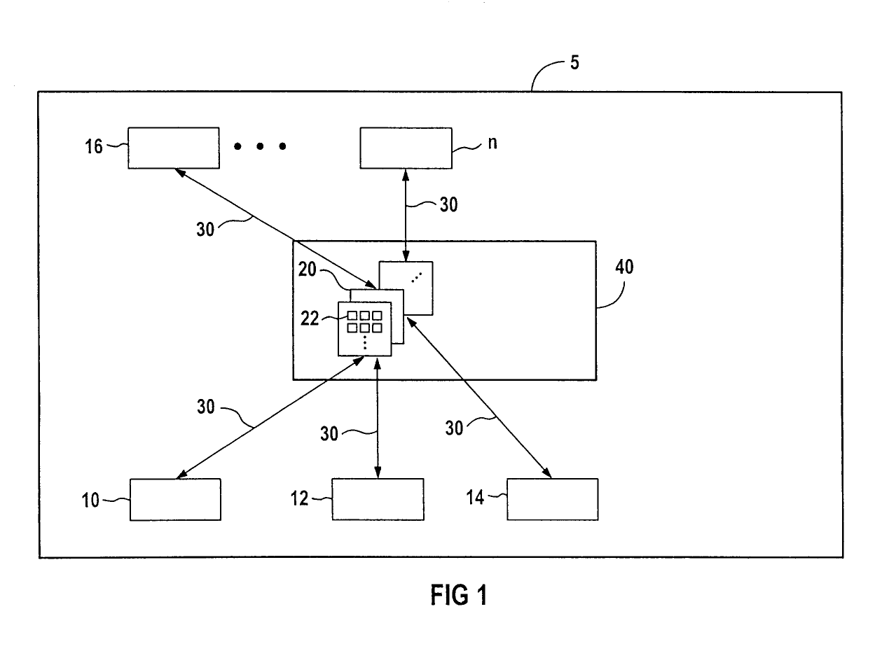

FIG. 1 shows a technical arrangement comprising several data processing systems which access a form container;

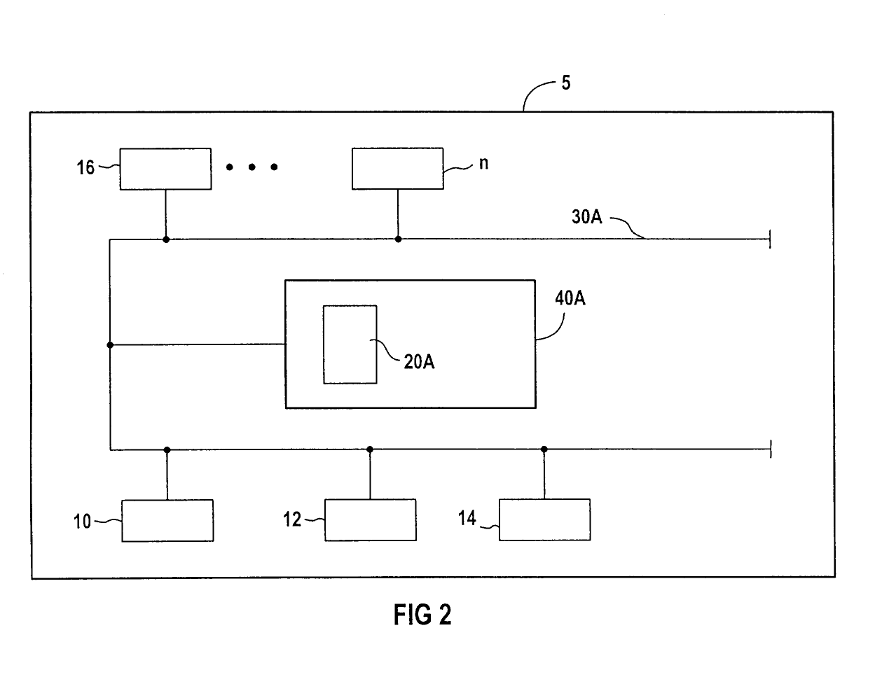

FIG. 2 shows a technical arrangement comprising several data processing systems and a form container which are interconnected by means of a communication bus;

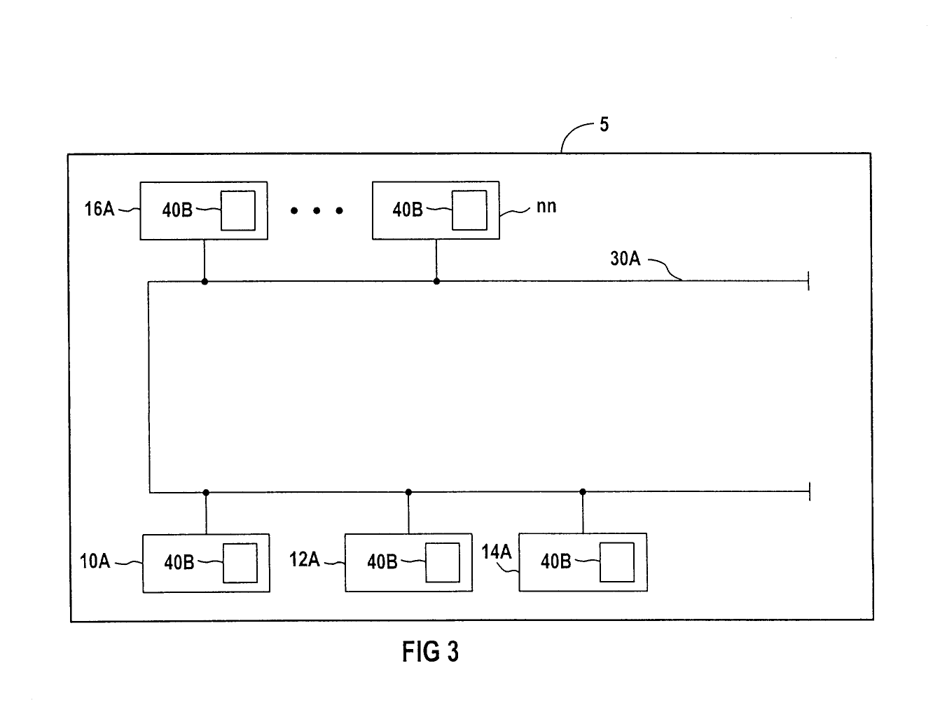

FIG. 3 shows a technical arrangement comprising several data processing systems which each contain a form container in the form of a data object structure; and

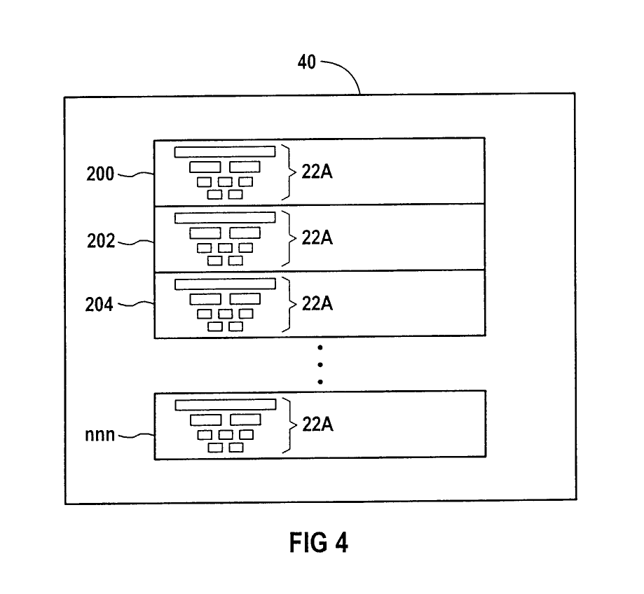

FIG. 4 shows a form container with a plurality of blank forms which each contain a composite, hierarchically structured variable.

FIG. 1 shows a technical arrangement 5 comprising several data processing systems 10, 12, 14, 16, . . . , n to which the tasks of the technical arrangement are allocated. The data processing systems are connected in each case by a bidirectional connection 30, which permits write and read access, to blank forms 20 which contain variables in each case. The blank forms 20 are collected in a form container 40.

The blank forms 20 contain the specifications of the information to be transmitted between the data processing systems during operation of the arrangement 5; the variables 22 of the blank forms 20 serve to record the current information values during operation of the arrangement 5. To solve the tasks of the technical arrangement 5 during operation, normally information must be exchanged between the data processing systems 10, 12, 14, 16, . . . , n. This is accomplished in that, using the bidirectional communication connection 30, one data processing system enters the information values required by a further data processing system to solve a task into the variables 22 of the relevant blank form for the task. Using the bidirectional communication connection 30, the receiving data processing system reads the information values it requires to solve a task from the blank forms filled out by other data processing systems.

The communication between the data processing systems 10, 12, 14, 16, . . . , n is handled efficiently since all data processing systems use for this purpose a uniform data structure specified on the blank forms 20 assigned to the tasks. No conversion of various data structures into one another is required in order to establish communication. The overview over the data to be transmitted between the data processing systems is preserved in particular because the blank forms 20 on which said information is specified are collected in a form container 40. Adaptation of communication during operation is readily possible, in that additional variables 22 are added to the blank forms 20 and even additional blank forms 20 may be added to the form container 40.

FIG. 2 shows a technical arrangement 5 comprising several data processing systems 10, 12, 14, 16, . . . , n and a form container which is designed as a computer unit 40a. The data processing systems and the computer unit 40a are interconnected via a communication bus 30a. The data processing systems access the blank forms via said communication bus 30a, which forms are designed as composite variables in the computer unit 40a.

FIG. 3 shows a technical arrangement 5 comprising several data processing systems 10a, 12a, 14a, 16a, . . . , nn which are interconnected via a communication bus 30a. The data processing systems contain in each case a form container which is designed as a data object structure 40b. The specification of the information to be transmitted between the data processing systems is thus not centrally stored in a separate unit as a form container for all data processing systems, but rather each of the data processing systems has its own form container designed as a data object structure 40b. At least the blank forms specifying the information to be transmitted and/or received by the respective data processing system in order to perform a task of the technical arrangement 5 are located in each case in each of these individual form containers.

If the data processing systems contained in the technical arrangement 5 use internal data structures that do not correspond at least to parts of the data object structure 40b, then adaptation to the data object structure 40b advantageously takes place within the respective data processing systems. Only the data object structure 40b which is uniform across the entire arrangement is then used for external communication between the data processing systems.

FIG. 4 shows a form container 40 that contains a plurality of blank forms 200, 202, 204, . . . , nnn. A hierarchically composite variable 22a is declared on each of these blank forms. At least one task, which can comprise a plurality of subtasks, of the technical arrangement is advantageously assigned to each of said blank forms. The information to be transmitted between the data processing systems in order to solve a task or a subtask is stored in the particular hierarchically composite variables 22a that belong to the blank form assigned to the respective task. In an especially advantageous development, the subtasks are assigned in each case to one hierarchical level of the hierarchically composite variables 22a. In this way the information to be transmitted for solving a task of the technical arrangement is recorded in contiguous data blocks and communication is particularly efficient, since all the relevant information for solving a task is present contiguously in a data structure which is uniform across the entire arrangement.

1. A method for operating a technical arrangement comprising several data processing systems, having the following steps:
a) the tasks of the technical arrangement (5) are defined in advance;
b) the tasks are allocated to the data processing systems (10, 12, 14, 16, . . . , n) in advance;
c) blank forms (20) are created in advance, on which forms the variables (22) whose contents are provided for performing at least one task for the exchange between the data processing systems during subsequent operation are declared in each case; and
d) during operation of the arrangement (5), the tasks of the technical arrangement are processed by the data processing systems (10, 12, 14, 16, . . . , n), wherein the particular data processing systems that make information values available to other data processing systems enter at least one information value on at least one blank form (20) relating to the task, and the particular data processing systems that receive information values from at least one other data processing system read out at least one information value from at least one blank form (20) relating to the task, which form was filled out by at least one other data processing system.

2. The method as claimed in claim 1, characterized in that additional variables are declared on the blank forms (20) during operation of the arrangement (5).

3. The method as claimed in one of claims 1 or 2, characterized in that additional blank forms are created during operation of the arrangement.

4. The method as claimed in one of claims 1 to 3, wherein the blank forms (20) are collected in at least one form container (40).

5. The method as claimed in one of claims 1 to 4, wherein the blank forms (20) are collected in exactly one form container (40).

6. The method as claimed in one of claims 1 to 5, wherein a blank form (20) is a—in the electronic data processing sense—composite variable.

7. The method as claimed in one of claims 4 or 5, wherein a form container (40) is an electronic data processing object structure.

8. The method as claimed in one of claims 1 to 7, wherein the tasks of the technical arrangement (5) comprise a plurality of subtasks in each case.

9. The method as claimed in claim 8, wherein the blank forms (20) are hierarchically structured and each hierarchical level is assigned to at least one subtask.

10. A device for operating a technical arrangement comprising several data processing systems, wherein
a) at least one task of the technical arrangement (5) is assigned to each data processing system (10, 12, 14, 16, . . . , n);
b) blank forms (20A) are created in a computer unit (40A), on which forms the variables whose contents are provided for performing at least one task for the exchange between the data processing systems during subsequent operation are declared in each case; and
c) the data processing systems (10, 12, 14, 16, . . . , n) are trained to process the tasks of the technical arrangement (5) during operation, and the particular data processing systems that make information values available to other data processing systems have means that enable them to enter at least one information value on at least one blank form (20) relating to the task, and the particular data processing systems that receive information values from at least one other data processing system have means that enable them to read out at least one information value from at least one blank form (20) relating to the task, which form was filled out by at least one other data processing system.

11. The device as claimed in claim 10, characterized in that means are available with which additional variables can be declared on the blank forms during operation of the arrangement (5).

12. The device as claimed in claim 10 or 11, characterized in that means are available with which additional blank forms can be created during operation of the arrangement (5).

13. The device as claimed in one of claims 10 to 12, wherein the blank forms (20) are collected in at least one form container (40).

14. The device as claimed in one of claims 10 to 13, wherein the blank forms (20) are collected in exactly one form container (40).

15. The device as claimed in one of claims 10 to 14, wherein the tasks of the technical arrangement are divided into a plurality of subtasks in each case.

16. The device as claimed in claim 15, wherein the blank forms (20) are hierarchically structured and each hierarchical level is assigned to at least one subtask.
